(19) United States
(12) Patent Application Publication
(10) Pub. No.: US 2009/0156339 A1
(43) Pub. Date: Jun. 18, 2009

(54) CHAIN GUIDE FOR TRANSMISSION DEVICE

(75) Inventor: Masanori Yokoyama, Osaka (JP)

Correspondence Address: HOWSON & HOWSON LLP, 501 OFFICE CENTER DRIVE, SUITE 210, FORT WASHINGTON, PA, 19034, US

(73) Assignee: TSUBAKIMOTO CHAIN CO., Osaka (JP)

(21) Appl. No.: 12/254,194

(22) Filed: Oct. 20, 2008

(30) Foreign Application Priority Data
Dec. 17, 2007 (JP) 2007-324758

(51) Int. Cl. F16H 7/18

(52) U.S. Cl. 474/111

(57) ABSTRACT

In an engine timing transmission, one end of a unitary molded glass fiber-reinforced resin chain guide is pivotally supported on a bolt fixed to an engine block. A supporting portion adjacent the opposite end of the chain guide is in abutting relationship with the engine block. An intermediate supporting portion on the chain guide is spaced from the engine block, but, when tension in the chain increases, the chain guide flexes, allowing the intermediate supporting portion to come into abutting relationship with the engine block. Through holes in the chain guide allow deformation of the supporting portions.

### CROSS-REFERENCE TO RELATED APPLICATION

This application claims priority on the basis of Japanese patent application 2007-324758, filed Dec. 17, 2007. The disclosure of Japanese application 2007-324758 is hereby incorporated by reference.

### FIELD OF THE INVENTION

The invention relates to improvements in chain guides used to restrict the path of travel of a transmission chain which transmits power from a driving sprocket to one or more driven sprockets in the timing drive of an automobile engine.

### BACKGROUND OF THE INVENTION

In general, an engine is provided with a valve timing transmission, which transmits power through a chain engaged with a driving sprocket on the engine crankshaft and one or more driven sprockets on the engine's valve-operating camshaft or camshafts. In a typical valve timing transmission, as shown in FIG. 1, a pivoted tensioner lever GA has a shoe is in sliding engagement with a portion of the chain CH traveling from a driving sprocket S1 toward a driven sprocket S2. The lever GA is biased by a tensioner T against the chain CH to apply proper tension, thereby preventing vibration of the chain. The lever GA is pivoted on a shaft P, which can be a part of a bolt or the like, fixed to the engine block.

A fixed chain guide GB is provided on the opposite side of the valve timing transmission for sliding engagement with a portion of the chain traveling from a driven sprocket S2 toward the driving sprocket S1. The fixed guide GB, which restricts the path of travel of the chain, is mounted on the engine block E by two bolts Q, or other suitable attaching pins or the like, which secure the guide against movement.

The fixed chain guide GB is typically composed of a high strength, light weight, base composed of a glass fiber-reinforced plastic resin, and a shoe composed of a plastic resin without glass fibers.

A typical timing transmission of the kind illustrated in FIG. 1 is described in more detail in United States Patent Application Publication 2007/0155555, published Jul. 5, 2007. A problem with the conventional fixed chain guide GB is that its base and its shoe are composed of different materials, making it expensive to manufacture and not suitable to meet the increasing demand for low cost engines.

Furthermore, since the conventional fixed chain guide GB is secured to the engine block by two bolts or similar securing means, it is unable to move to accommodate an increase in chain tension. Consequently, an increase in chain tension can cause excessive frictional heating of the unreinforced shoe, resulting in deformation due to differential thermal expansion of the base and the shoe. Excessive thermal deformation can, in turn, result in the formation of cracks, separation of the shoe from the base, and a decrease in the strength of the guide due to thermal deterioration. Furthermore, since the chain guide GB is unable to adapt to movements of the chain resulting from an increase or decrease in chain tension, tension in the part of the chain traveling toward the driving sprocket is not as well-maintained as the tension in the part of the chain traveling away from the driving sprocket.

Accordingly, an object of the invention is to solve the above-mentioned problems, and to provide a chain guide in which thermal deterioration can be reduced at a low cost, and which can flexibly follow displacement of the chain resulting from changes in chain tension.

### SUMMARY OF THE INVENTION

The chain guide according to the invention is used in combination with an engine incorporating an engine block and including a chain transmission. The chain guide comprises an elongated guide body having opposite first and second ends spaced from each other along the direction of elongation of the guide body, and a sliding contact surface in sliding engagement with the chain of the chain transmission. The first end of the chain guide is pivotally supported on a mounting shaft fixed to the engine block. An end-supporting portion of the guide body adjacent the second end of the guide body is in abutting relationship with the engine block, and a central supporting portion of the guide body, at an intermediate location between the first and second ends, is spaced from the engine block when the tension in the chain is below a predetermined level, but in abutting contact with the engine block when the tension in the chain is at and above said predetermined level.

Whereas two mounting bolts are typically needed to support a conventional fixed guide, the guide of the invention can be supported by a single mounting bolt or other suitable mounting shaft. Therefore, the number of parts is reduced, and the guide can be installed more quickly and easily. Moreover, the guide according to the invention can be mounted close to the engine block, and therefore, the overall size and weight of the engine can be reduced. The simplification of guide mounting and engine size reduction afforded by the invention can result in significantly reduced costs.

The guide body can have a plurality of central supporting portions at intermediate locations between its first and second ends, in which case the central supporting portions are spaced from the engine block when the tension in the chain is below a predetermined level, but in abutting contact with the engine block when the tension in the chain is at and above said predetermined level.

With plural central supporting portions, the guide body can flexibly follow changes in chain tension without excessive generation of heat as a result of friction between the chain and the guide body. Therefore, loss of strength due to thermal deterioration can be suppressed.

Preferably, the guide body has at least one through hole adjacent the end-supporting portion, and at least one through hole adjacent each of its central supporting portions. The through holes can be provided in various shapes and numbers, and enhance the elasticity of the end-supporting portion and the central supporting portion or portions. Even if a sudden increase in chain tension occurs, causing a strong impact between the guide body and the engine block, the impact is absorbed by the central supporting portion, the elasticity of which is enhanced by a through hole, so that the application of excessive loads to the guide body is avoided. Moreover, the elasticity of the guide body can be adjusted easily by adopting appropriate through holes. The guide body can easily follow changes in chain tension, and therefore the guide of the invention affords a high degree of flexibility in the adjustment of the tension-controlling properties of the chain transmission.

The guide body is preferably a unitary molded body composed of glass fiber-reinforced plastic resin. The unitary molded construction results in a reduction in cost compared to that of conventional fixed guides. Furthermore, glass fiber-reinforced plastic resin has a better thermal conductivity than a conventional plastic resin. Consequently, frictional heat generated by sliding of the chain on the guide body is more effectively dissipated.

### BRIEF DESCRIPTION OF THE DRAWINGS

FIG. 1 is a schematic front elevational view of a timing transmission in a dual overhead cam (DOHC) internal combustion engine, incorporating both a movable chain guide and a fixed chain guide;

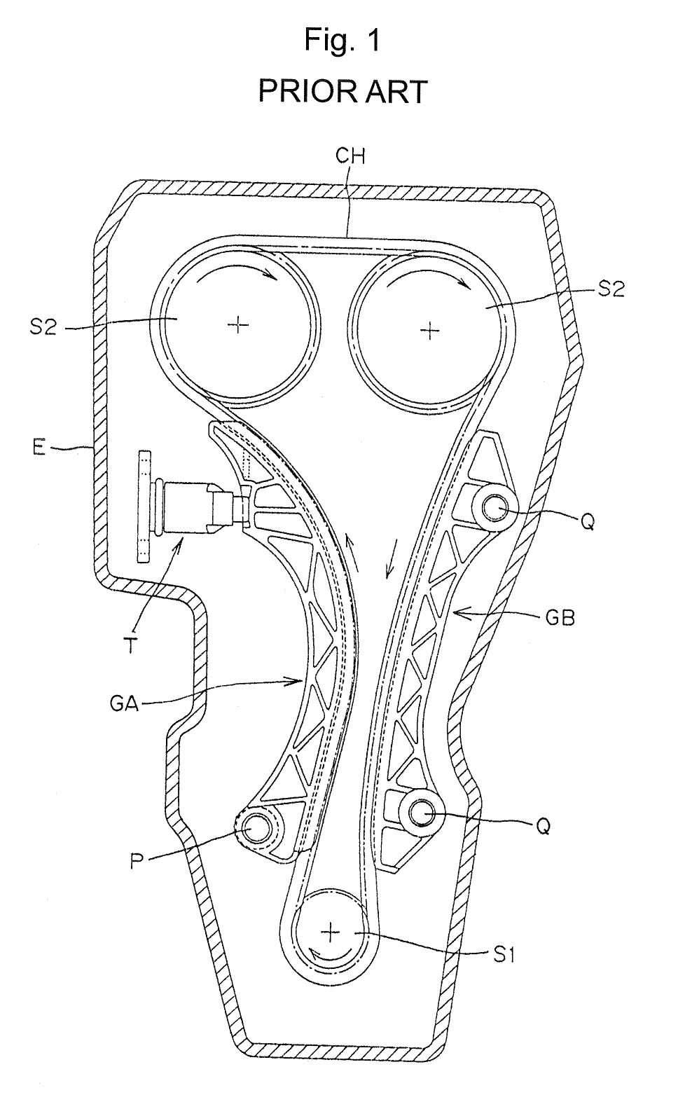

FIG. 2 is an elevational view showing a first embodiment of a chain guide according to the invention in sliding contact with a chain under low tension;

FIG. 3 is an elevational view showing the condition of the first embodiment of the chain guide when the chain is under increased tension;

FIG. 4 is an elevational view showing a second embodiment of a chain guide according to the invention in sliding contact with a chain under low tension;

FIG. 5 is an elevational view showing the condition of the second embodiment of the chain guide when the chain is under increased tension;

FIG. 6 is an elevational view showing a third embodiment of a chain guide according to the invention in sliding contact with a chain under low tension; and

FIG. 7 is an elevational view showing the condition of the third embodiment of the chain guide when the chain is under increased tension.

### DETAILED DESCRIPTION OF THE PREFERRED EMBODIMENTS

In general, the chain guide of the invention is pivoted at one end, abuts the engine block at its other end, and has an intermediate supporting portion that moves away from the engine block as the chain loosens, but moves into abutment with the engine block as tension in the chain increases. The chain guide can be realized in various embodiments, the preferred ones of which will be described below.

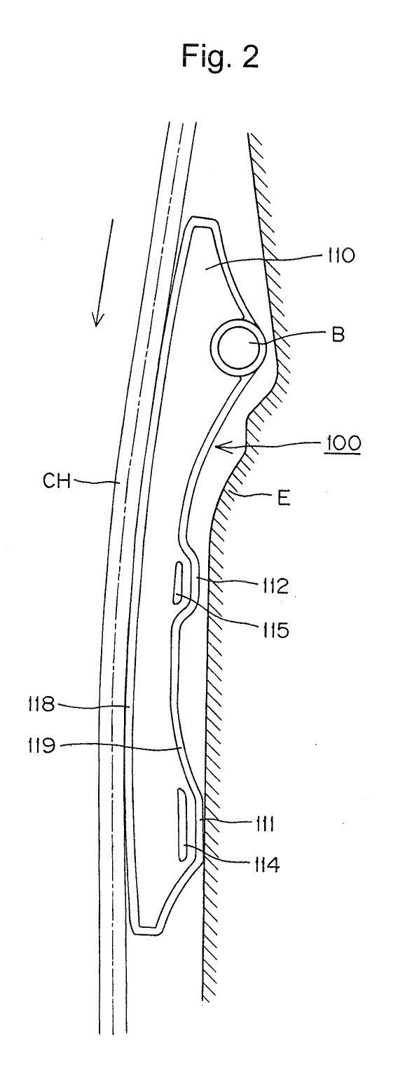

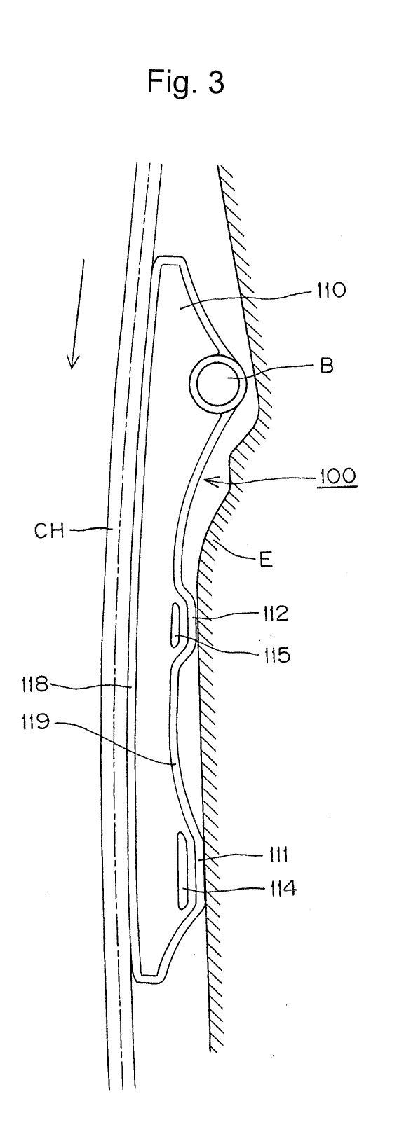

In a first embodiment, illustrated in FIGS. 2 and 3, chain guide 100 comprises an elongated guide body 110, which includes a shoe portion 118 in the form of a gradual arc. A chain CH is in sliding contact with a surface of the shoe which extends along the direction of the length of the chain. The side of the guide body opposite from the chain-contacting shoe surface is in the form of an arch 119. The shoe is resilient, and elastically deformable in a direction perpendicular to the longitudinal direction. Adjacent one end of the arch 119, the guide body 110 is pivotally supported on a shaft, which can be a bolt B fixed to an engine block E. An end-supporting portion 111 at the opposite end of the arch 119 abuts the engine block E. This end-supporting portion 111 has a flat surface that contacts the engine block E over an area rather than at a point or a line of contact, thereby avoiding concentration of stress that could shorten the useful life of the guide. The chain guide also has a central supporting portion 112, which does not abut the engine block E when the chain CH is loose, but abuts the engine block E, as illustrated in FIG. 3, when the tension in the chain increases, causing the guide body to bend. The central supporting portion 112 also has a flat surface for contact with the engine block, and abuts the engine block when the tension in the chain exceeds a predetermined limit.

Slot-shaped through holes 114 and 115 are provided adjacent the end supporting portion 111 and the central supporting portion 112 respectively. These slot-shaped through holes extend along the direction of the length of the guide body 110, and are preferably positioned directly behind the flat, engine block-engaging surfaces of the guide body. These through holes 114 and 115 allow the end-supporting portion 111 and the central supporting portion 112 to deform easily in a direction perpendicular to the longitudinal direction of the guide body 110. Therefore, when the tension in chain CH increases, the increased tension is absorbed by deformation of the supporting portions 111 and 112, as shown in FIG. 3. Although the through holes are preferably in the form of slots elongated along the direction of the length of the guide body, through holes having various other sizes, shapes, and positions can be adopted. Moreover, multiple through holes can be provided adjacent either or both of the supporting portions of the guide body.

The guide body 110 is preferably molded as a unit from a glass fiber-reinforced plastic resin such as polyamide 66. Because entire the guide body is molded as a unit, the process of manufacture of the guide body simplified, and the guide body can be manufactured inexpensively.

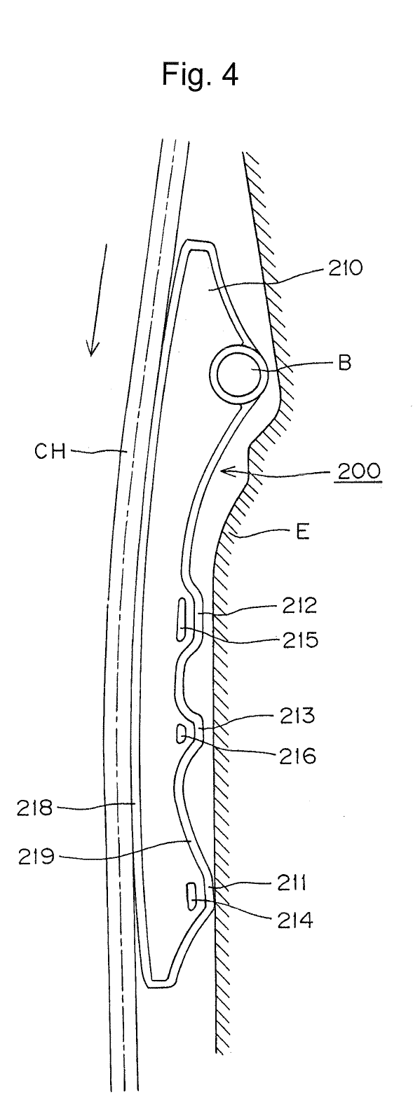

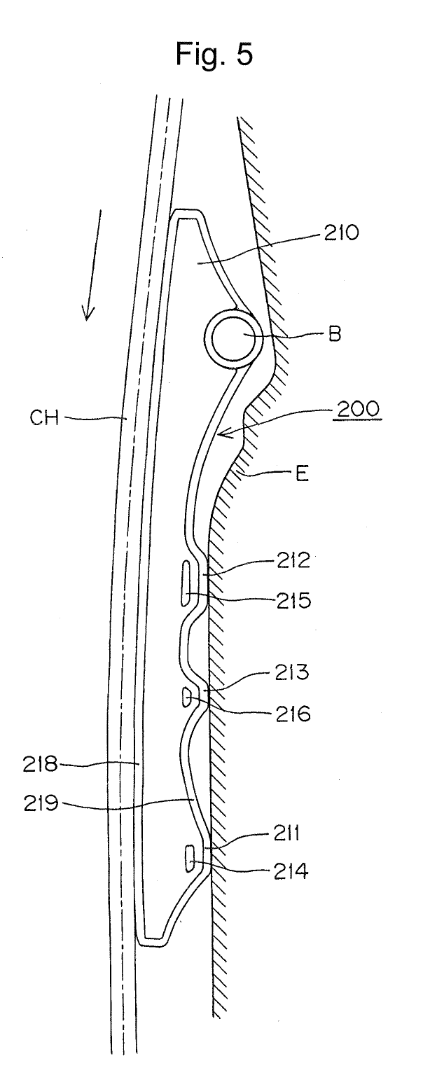

In the embodiment shown in FIGS. 4 and 5, chain guide 200 comprises an elongated guide body 210, which includes a shoe portion 218 in the form of a gradual arc. A chain CH is in sliding contact with a surface of the shoe which extends along the direction of the length of the chain. The side of the guide body opposite from the chain-contacting shoe surface is in the form of an arch 219. The shoe is elastically deformable in a direction perpendicular to the longitudinal direction. Adjacent one end of the arch 219, the guide body 210 is pivotally supported on a shaft, which can be a bolt B fixed to an engine block E. An end-supporting portion 211 at the opposite end of the arch 219 abuts the engine block E. This end-supporting portion 211 has a flat surface that contacts the engine block E over an area, thereby avoiding concentration of stress that could shorten the useful life of the guide.

The chain guide also has two central supporting portions, 212 and 213, which do not abut the engine block E when the chain CH is loose, but abut the engine block E, as illustrated in FIG. 5, when the tension in the chain exceeds a predetermined limit. These central supporting portions also have flat surfaces for area contact with the engine block.

A slot-shaped through hole 211 is provided in the guide body adjacent the end-supporting portion 214, and slot-shaped through holes 216 and 215 are provided in the guide body adjacent the central supporting portion 213 and 212, respectively. These slot-shaped through holes extend along the direction of the length of the guide body 210, and are preferably positioned directly behind the flat, engine block-engaging surfaces of the guide body. These through holes, 214, 216 and 215, allow the end-supporting portion 211 and the central supporting portions, 213 and 212, to deform easily in a direction perpendicular to the longitudinal direction of the guide body 210. Therefore, when the tension in chain CH increases, the increased tension is absorbed by deformation of the supporting portions, as shown in FIG. 5. Here again, although the through holes are preferably in the form of slots elongated along the direction of the length of the guide body, through holes having various other shapes, sizes and locations can be adopted. Moreover, multiple through holes can be provided adjacent any or all of the supporting portions of the guide body.

The guide body 210 is preferably molded as a unit from a glass fiber-reinforced plastic resin such as polyamide 66. Because entire the guide body is molded as a unit, the process of manufacture of the guide body simplified, and the guide body can be manufactured inexpensively.

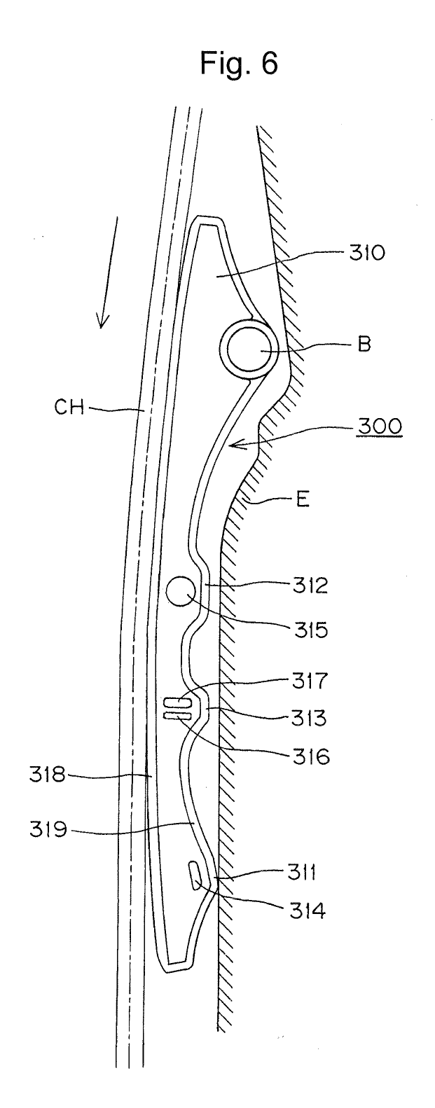

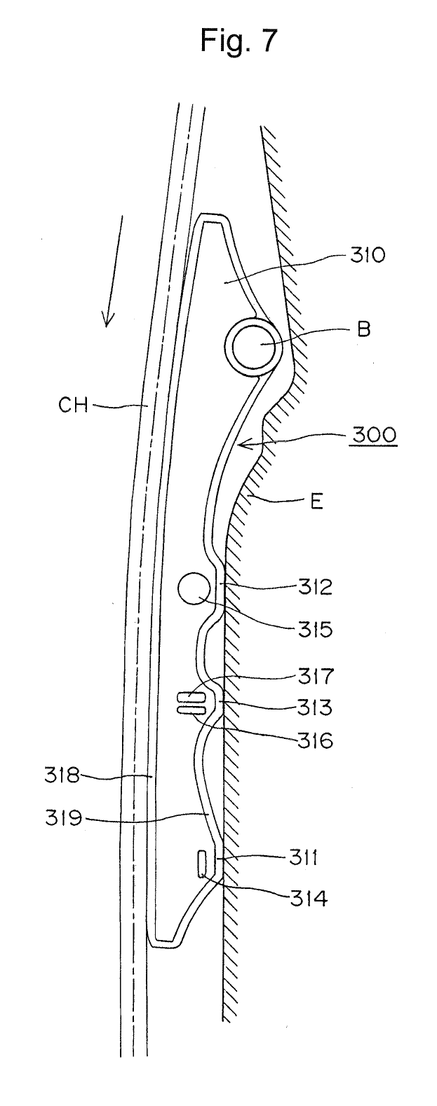

In the embodiment shown in FIGS. 6 and 7, chain guide 300 comprises an elongated guide body 310, which includes a shoe portion 318 in the form of a gradual arc. A chain CH is in sliding contact with a surface of the shoe which extends along the direction of the length of the chain. The side of the guide body opposite from the chain-contacting shoe surface is in the form of an arch 319. The shoe is elastically deformable in a direction perpendicular to the longitudinal direction. Adjacent one end of the arch 319, the guide body 310 is pivotally supported on a shaft, which can be a bolt B fixed to an engine block E. An end-supporting portion 311 at the opposite end of the arch 319 abuts the engine block E. This end-supporting portion 311 has a flat surface that contacts the engine block E over an area, thereby avoiding concentration of stress that could shorten the useful life of the guide.

The chain guide of FIGS. 6 and 7 also has two central supporting portions, 312 and 313, which do not abut the engine block E when the chain CH is loose, but abut the engine block E, as illustrated in FIG. 7, when the tension in the chain exceeds a predetermined limit. These central supporting portions also have flat surfaces for area contact with the engine block.

A slot-shaped through hole 311 is provided in the guide body adjacent the end-supporting portion 314. A circular through hole 315 is provided in the guide body adjacent central supporting portion 312. Two slot-shaped through holes, 316 and 317 are provided adjacent central supporting portion 313. These slot-shaped through holes 316 and 317 extend perpendicular to the direction of the length of the guide body 310. These through holes, 314, 315, 316, and 317, allow the end-supporting portion 311 and the central supporting portions, 312 and 313, to deform easily in a direction perpendicular to the longitudinal direction of the guide body 310. Therefore, when the tension in chain CH increases, the increased tension is absorbed by deformation of the supporting portions, as shown in FIG. 7. Here, as in the previously described embodiments, the sizes, shapes, positions, and numbers of the through holes can be varied while still affording the supporting portions guide body with the ability to deform when tension in the chain increases.

The guide body 310 is preferably molded as a unit from a glass fiber-reinforced plastic resin such as polyamide 66. Because entire the guide body is molded as a unit, the process of manufacture of the guide body simplified, and the guide body can be manufactured inexpensively.

We claim:

1. The combination of an engine comprising an engine block and a chain transmission including a chain, and a chain guide, and a mounting shaft fixed to the engine block, said chain guide comprising an elongated guide body having opposite first and second ends spaced from each other along the direction of elongation of the guide body, and a sliding contact surface in sliding engagement with the chain, wherein the first end of the chain guide is pivotally supported on the mounting shaft, an end-supporting portion of the guide body adjacent the second end of the guide body is in abutting relationship with the engine block, and a central supporting portion of the guide body, at an intermediate location between said first and second ends, is spaced from the engine block when the tension in the chain is below a predetermined level, but in abutting contact with the engine block when the tension in the chain is at and above said predetermined level.

2. The combination of claim 1, in which said guide body has a plurality of central supporting portions at intermediate locations between said first and second ends, said central supporting portions being spaced from the engine block when the tension in the chain is below a predetermined level, but in abutting contact with the engine block when the tension in the chain is at and above said predetermined level.

3. The combination of claim 1, in which said guide body has at least one through hole adjacent said end-supporting portion and at least one through hole adjacent said central supporting portion.

4. The combination of claim 1, in which said guide body is a unitary molded body composed of glass fiber-reinforced plastic resin.

5. The combination of claim 1, in which said guide body has a plurality of central supporting portions at intermediate locations between said first and second ends, said central supporting portions being spaced from the engine block when the tension in the chain is below a predetermined level, but in abutting contact with the engine block when the tension in the chain is at and above said predetermined level, and in which said guide body has at least one through hole adjacent said end-supporting portion and at least one through hole adjacent each of said central supporting portions.

6. The combination of claim 1, in which said guide body has a plurality of central supporting portions at intermediate locations between said first and second ends, said central supporting portions being spaced from the engine block when the tension in the chain is below a predetermined level, but in abutting contact with the engine block when the tension in the chain is at and above said predetermined level, and in which said guide body is a unitary molded body composed of glass fiber-reinforced plastic resin.

7. The combination of claim 1, in which said guide body has at least one through hole adjacent said end-supporting portion and at least one through hole adjacent said central supporting portion, and in which said guide body is a unitary molded body composed of glass fiber-reinforced plastic resin.

8. The combination of claim 1, in which said guide body has a plurality of central supporting portions at intermediate locations between said first and second ends, said central supporting portions being spaced from the engine block when the tension in the chain is below a predetermined level, but in abutting contact with the engine block when the tension in the chain is at and above said predetermined level, in which said guide body has at least one through hole adjacent said end-supporting portion and at least one through hole adjacent each of said central supporting portions, and in which said guide body is a unitary molded body composed of glass fiber-reinforced plastic resin.
